(19) United States
(12) Patent Application Publication
(10) Pub. No.: US 2026/0225918 A1
(43) Pub. Date: Aug. 6, 2026

(54) DISPENSING DEVICE FOR PURIFIED WATER

(71) Applicant: Merck Patent GmbH, Darmstadt (DE)

(72) Inventors: Laurent Moreau, Versailles (FR); Thierry Cassou, Montigny le Bretonneux (FR)

(21) Appl. No.: 19/159,948

(22) PCT Filed: Mar. 21, 2024
(86) PCT No.: PCT/EP2024/057518

§ 371 Date: Aug. 26, 2025

(30) Foreign Application Priority Data
Mar. 23, 2023 (EP) 23305393.3

(51) Int. Cl. C02F 1/00; B01L 3/02; C02F 9/20; C02F 103/04

(52) U.S. Cl. CPC C02F 1/006; B01L 3/02; C02F 9/20; C02F 2103/04; C02F 2201/005

(57) ABSTRACT

The present application relates to a dispensing device for purified water, more particularly to a dispensing device for ultrapure water. The present application also relates to a water purification system comprising such a dispensing device for purified water as well as to a method for dispensing purified water.

### TECHNICAL FIELD

The present application relates to a dispensing device for purified water, more particularly to a dispensing device for ultrapure water. The present application also relates to a water purification system comprising such a dispensing device for purified water as well as to a method for dispensing purified water.

### BACKGROUND

Various applications in the pharmaceutical, life science or semiconductor areas require water of a higher purity than that of natural water or water coming from the faucet (“tap water”) so as avoid or at least reduce the occurrence of undesired side reactions or negatively influence reproducibility in analytical or production processes through the introduction of contaminants. Thus, depending upon the targeted application, water purity has to be improved by at least partly removing the contaminants comprised in the water. The highest purity water, often denoted as “ultrapure” or in accordance with ASTM D 1193-06 as “Type I” water, is, for example, characterized by a resistivity of at least 18.0 MΩ·cm and at most 5 ppb of total organic carbon (TOC). “Type II” water is typically characterized by a resistivity of at least 1.0 MΩ·cm and at most 50 ppb of total organic carbon. “Type III” water is the lowest quality water grade for laboratory use, having a resistivity of at least 0.05 MΩ·cm and at most 200 ppb of total organic carbon, and is recommended for standard laboratory use, such as for glassware rinsing or heating baths, as well as a feed to water purification systems producing Type I water.

Water purification systems allowing to produce ultrapure or Type I water are known as such. An integral water purification system designed to purify water from tap water comprises various water purification steps such as, for example, filtration, reverse osmosis, electrodeionization, UV radiation treatment, ion exchange steps. Generally, such purification system comprises a first purification stage, wherein tap water is purified to a first purity grade (for example, Type II or lower as defined by ASTM D 1193-06), and a second purification stage, wherein the pre-purified water from the first purification stage is further purified to a higher purity (for example, Type I as defined by ASTM D 1193-06), which can then be dispensed from the system and used.

Purifying water to the ultrapure level is a challenge because the acceptable levels of contaminants are very low. Thus, to avoid build-up of contaminants in the water purification system and the dispensing section, for example, when no water is dispensed from the system, the purified water needs to be continuously re-circulated throughout the system, for example, by continuous re-circulation through the first and second purification stages as well as through the dispensing device.

In many commercially available water purification systems the dispenser for the dispensing of purified water from the system is, for reasons of user convenience, mobile so that the user can move it, within a given range, to the actual point-of-use without having to displace the heavy water purification system as a whole. This necessitates a feeding line providing in a first flow path purified water from the preceding purification stages to the dispensing device and in a second flow path circulate purified water that has not been dispensed back again for re-circulation. Furthermore, as the dispensing devices comprise solenoid and/or motorized valves, an electrical cable providing this/these valve(s) with electricity is required in addition. To avoid damaging the feeding line and the electrical cable, these are frequently surrounded by a sheath for protection. In consequence, the feeding line gets to be rather thick and heavy, resulting in reduced flexibility.

For example, in a commercially available state of the art water purification system (100) as disclosed in EP 1 814 007 A1, of which the flow schematic is shown in FIG. 1, wherein reference numerals (146) and (147) indicate first and second flow paths providing purified water to the dispenser, the dispenser comprising an outlet (102), a filter (107), and a distribution solenoid valve (120). In such commercially available state of the art water purification system each of first and second flow paths is realized by a tube having an inner diameter of 6 mm and an outer diameter of 8 mm, thus reducing due to their thickness alone, the flexibility and ergonomics of the feeding line.

In such water purification systems, the flow of purified water through the water outlet of the dispenser is generally controlled through opening and closing of the water outlet by means of a solenoid valve. However, solenoid valves only have an on-off setting and cannot control the rate of flow of the purified water to be dispensed. For this reason, solenoid valves are sometimes coupled with a motorized valve, thereby allowing the user to precisely control the rate of flow of the dispensed water from drop-by-drop (or “dropwise”) dispensing to high flowrates. Both, the solenoid valve and the motorized valve can be integrated together in the dispenser, or—alternatively—the motorized valve can be placed remotely, for example in a remote central unit, with only the solenoid valve being in the actual dispenser.

Water purification systems and distribution systems for ultrapure water are, for example, also described in U.S. Pat. No. 5,925,240 A; WO 2010/043899 A1; and U.S. Pat. No. 11,035,484 B2.

However, the existing water purification systems and particularly the distribution systems and dispensing devices have a number of drawbacks, such as for example:
(i) A PCB (“printed circuit board”) with electronics must be integrated in the dispensing unit, with electric power transferred from the remote main system to the dispenser or dispensing device;
(ii) the solenoid valve and the motorized valve together are bulky components, which limit the integration and design options of the dispenser, to maintain ergonomic operation;
(iii) energizing the activation coil of a solenoid valve over an extended period of time can cause heating, which can compromise the quality of the purified water dispensed from the dispenser or dispensing device; and
(iv) in a system with more than one dispenser or dispensing device, a motorized valve coupled with several solenoid valves only allows for one flowrate setting at a time and it is not possible to set different flowrates for the different dispensers or dispensing devices.

There is therefore a need to overcome such and other drawbacks and render water purification systems, particularly water purification systems for laboratory applications and particularly the dispensing device more user-friendly and/or simplified in terms of construction, preferably in combination with reducing one or more of size, costs, and environmental impact.

Additionally, such water purification system preferably also allows for easy, ergonomic operation, and/or easy and robust assembly.

### SUMMARY

The present inventors have now surprisingly found that the above needs may be fulfilled either individually or in any combination by the dispensing device, the water purification system, and the method of the present application.

The present application therefore provides for a dispensing device for dispensing purified water, the dispensing device comprising
(a) a dispenser comprising a valve assembly and a water outlet; and
(b) a feeding line providing purified water to the dispenser and removing water from the dispenser,
wherein the feeding line comprises an integral multi-lumen tubing, the integral multi-lumen tubing comprising at least two separate lumens serving as flow paths for feeding water to and from the dispenser, respectively.

In addition the present application provides for a water purification system comprising such dispensing device.

Furthermore, the present application provides for a method of dispensing purified water, the method comprising the steps of
(A) providing such dispensing device as defined herein;
(B) providing purified water through a feeding line to the dispenser; and
(C) dispensing purified water through the dispenser.

### BRIEF DESCRIPTION OF THE DRAWINGS

FIG. 1 is a reproduction of FIG. 1 of EP 1 814 007 A1, showing a schematic representation of an exemplary flow schematic of a commercially available state of the art water purification system.

FIG. 2 shows a schematic representation of an exemplary water purification system of the present application.

FIG. 3a shows a schematic representation of an exemplary integral multi-lumen tubing as may be used herein.

FIG. 3b shows a schematic representation of the exemplary integral multi-lumen tubing of FIG. 3a surrounded by a tight protective sheath.

FIG. 3c shows a schematic representation of the exemplary integral multi-lumen tubing of FIG. 3a surrounded by a loose protective sheath.

FIG. 4 shows a perspective schematic view of an exemplary first disc of the valve assembly in accordance with the present application.

FIG. 5 shows a perspective schematic view of an exemplary second disc of the valve assembly in accordance with the present application.

FIG. 6 shows a schematic top view of an exemplary valve assembly in accordance with the present application with the first disc as shown in FIG. 4 and the second disc as shown in FIG. 5 superimposed on each other.

FIG. 7 shows a schematic representation of an exemplary dispenser of the present application.

FIG. 8a shows a schematic cross sectional view of an exemplary dispenser in accordance with the present application, with the valve assembly of the present application in the closed position.

FIG. 8b shows a schematic cross sectional view of an exemplary dispenser in accordance with the present application, with the valve assembly of the present application in an open position.

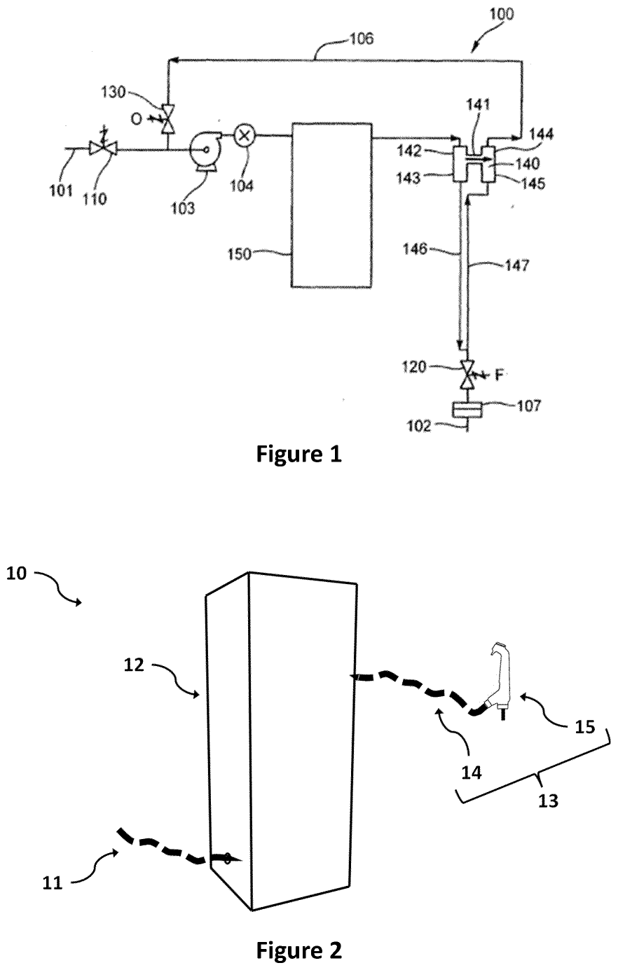

### DETAILED DESCRIPTION

For the purpose of the present application, the term “distribution system” is used to generally denote a system of bringing purified water from a water purification unit to a point of use. Such distribution system may, for example, comprise one or more selected from the group consisting of distribution devices, dispensing units, feeding lines, and/or dispersers, as defined herein.

For the purpose of the present application, the terms “feeding line” and “purified water feeding line” are consistently used to denote the feeding line providing purified water to the dispenser and removing the purified water that has not been dispensed (“non-dispensed purified water”), i.e. not drawn from the system for use, from the dispenser.

For the purpose of the present application, the term “raw water feed line” is consistently used to denote a line feeding raw water from an external source, such as for example tap water, for purification to a water purification system.

For the purpose of the present application, the term “lumen” is used to denote a continuous cavity extending along the longitudinal axis of a tubing. Throughout this application, such continuous cavity extending along the longitudinal axis of a tubing may also be referred to as “flow path” or “channel”.

The present application relates to a dispensing device for liquids, such as water, and particularly for dispensing purified water, for example ultrapure, i.e. Type I, water. The present dispensing device has been found to be particularly useful in water purification systems for laboratory applications. Such water purification systems for laboratory applications preferably have a dispensing rate (“maximum dispensing rate”) of at most 5 l·min⁻¹, more preferably of at most 4 l·min⁻¹, even more preferably of at most 3 l·min⁻¹ and most preferably of at most 2 l·min⁻¹. Though herein generally described in the context of such a water purification system, the present dispensing device may also be used in other applications, where accurate dispensing of liquids may be required.

Such a water purification system generally comprises a water feed, a water purification unit, and a dispensing device, which in turn comprises a feeding line and a dispenser. For reason of clarity, it is noted that the feeding line (fluidly) connects the water purification unit and the dispenser.

A schematic representation of such a water purification system (10) is shown in FIG. 2, comprising a raw water feed line (11), a water purification unit (12), and a dispensing device (13), the dispensing device (13) in turn comprising a feeding line (14), and a dispenser (15).

Means for water purification and thus the components generally comprised in a water purification unit to purify the raw water from an external source to the desired level of purity are generally known in the art and are, for example, disclosed in the already indicated documents.

### Feeding Line

The feeding line (or purified water feeding line) provides (or delivers) purified water to the dispenser and again removes water, which has not been dispensed from the dispenser, back to the water purification unit wherein it is then subjected to one or more purifying step. Providing such flow to and from (“cycling”) the dispenser avoids build-up of contaminants in stagnant water, for example by extraction from the materials used for the tubing to conduct the purified water. Such cycling may either be done continuously, or preferably in order to reduce energy consumption non-continuously, for example by regularly cycling for a period (or duration) of time sufficient to remove and/or re-purify any stagnant water in the loop (including the feeding line). The period of time from such cycling to another, i.e. the time in between cycling, may be determined, for example, on basis of the amount of contaminants introduced into the purified water in a certain period of time and/or what level of purity of the purified water is desired.

The present water feeding line comprises, or preferably consists of, an integral multi-lumen tubing. Such integral multi-lumen tubing comprises at least two (for example, two, or three, or four, or five, or six, or seven, or eight, or even more than eight) separate lumens in a single (“integral”) tubing serving as flow paths from feeding water to and from the dispenser, respectively. It is noted that, irrespective of the total number of lumens comprised in such integral multi-lumen tubing, at least one (for example, one, or two, or three, or four, or even more than four) lumen serves as flow path (or channel) to provide (purified) water to the dispenser, and at least one (for example, one, or two, or three, or four, or even more than four) lumen serves as flow path (or channel) to remove non-dispensed purified water from the dispenser.

Preferably, the present integral multi-lumen tubing comprises at least one (for example, one, or two, or three, or four, or even more than four) central lumen and at least one (for example, one, or two, or three, or four, or even more than four) peripheral (or outer) lumen, with each lumen separate from any other.

Preferably, the present integral multi-lumen tubing comprises at least two (for example, two, or three, or four, or five, or six, or seven, or eight, or even more than eight) lumens that are symmetrically distributed around at least one central lumen, with each lumen separate from any other.

Preferably, the present integral multi-lumen tubing comprises, or preferably consists of, a low-leachables material, preferably a low-leachables polymer. Such low-leachables polymer may, for example, be selected from the group consisting of polytetrafluoroethylene (PTFE), polyvinylidene fluoride (PVDF, also referred to as polyvinylidene difluoride), perfluoroalkoxy polymers (PFA), and low-density polyethylene (LDPE), with low-density polyethylene being preferred.

Preferably, the present feeding line comprises a protective sheath surrounding the integral multi-lumen tubing. Such a sheath may surround the integral multi-lumen tubing either tightly, i.e. without any free volume between the sheath and the outer surface of the integral multi-lumen tubing, or loosely, i.e. with free volume between the sheath and the outer surface of the integral multi-lumen tubing. Preferably, such sheath surrounds the integral multi-lumen tightly, with the sheath and the integral multi-lumen tubing being co-extruded. Co-extrusion of the sheath and the integral multi-lumen tubing results in strong adhesion between both, essentially making it an integral sheathed multi-lumen tubing.

Preferably, the protective sheath comprises, preferably consists of, a material different from that of the integral multi-lumen tubing.

Preferably, the present feeding line, including—if present—a protective sheath, is flexible. Such flexible feeding line is then preferably made of low-density polyethene. This will allow for easy handling of the dispensing device and improve ergonomics.

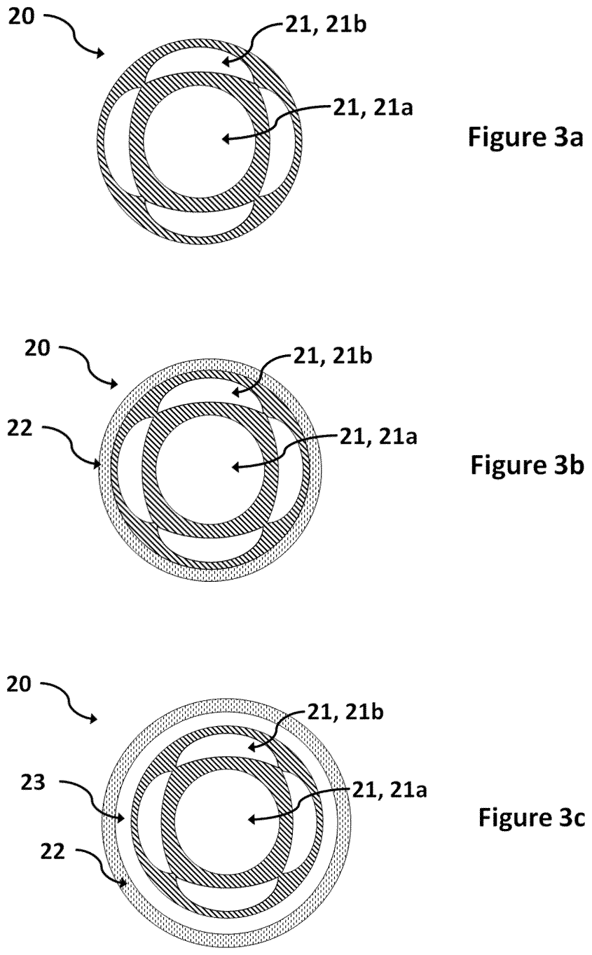

FIG. 3a schematically shows an exemplary integral multi-lumen tubing (20), which may be used herein, comprising a total of five lumens (21) separated from each other, with one central lumen (21a) and four peripheral lumens (21b) symmetrically arranged around the central lumen (21a).

FIG. 3b schematically shows the exemplary integral multi-lumen tubing (20) of FIG. 3a with a sheath (22) tightly surrounding the integral multi-lumen tubing (20).

FIG. 3c schematically shows the exemplary integral multi-lumen tubing (20) of FIG. 3a with a sheath (22) loosely surrounding the integral multi-lumen tubing (20), thus having a free volume (23) between the sheath and the integral multi-lumen tubing (20).

### Dispenser

Though the present dispenser may comprise any suitable valve arrangement allowing to control the flow of the to be dispensed purified water from dropwise up to the maximum dispensing rate of the system, it is nevertheless preferred that the dispenser comprises a valve assembly comprising two ceramic discs (or a “pair” of discs), which in the following may also be referred to as “first disc” and “second disc”, respectively.

Preferably, this pair of first disc and second disc is to be rotated relative to each other with mutually facing first and second sealing contact surfaces arranged to at least partly slide in contact with each other, wherein the first disc has at least one window, wherein the second disc has a solid portion arranged to completely cover and thus to close the at least one window of the first disc in a fully closed rotational position, and an opening portion arranged to at least partially expose the at least one window of the first disc in a fully open rotational position.

Preferably, the solid portion of the second disc that is arranged to completely cover to close the at least one window of the first disc in the fully closed rotational position is formed so as to include a portion of the second sealing contact surface that overlaps the first sealing contact surface of the first disc surrounding an edge of the window by a sealing zone with a width of at least 1.5 mm, preferably at least 2.0 mm.

Preferably, the first and second sealing contact surfaces of the pair of first and second discs arranged to at least partly slide in contact with each other have a surface roughness Ra of at most 0.60 μm, and/or a surface flatness of at most 0.80 μm, and are preferably polished or ground.

Preferably, the mutually facing first and second sealing contact surfaces of the pair of first and second discs are arranged such that a percentage of 50-80%, preferably 55-75%, most preferably 60-70% of the first and second sealing contact surfaces are sliding in contact with each other between the fully closed rotational position and the fully open rotational position.

Preferably, the second disc is freely floating in contact with the first disc or is biased towards the first disc by a biasing member.

Preferably, the at least one window of the first disc has a notch/dent recessed into the material of the first disc from the plane defined by the first sealing contact surface of the first disc at an/the edge of the at least one window at a side where the exposure of the at least one window starts upon movement of the second disc from the fully closed rotational position in the direction towards the fully open rotational position.

Preferably, the notch/dent has a pointed tip widening and/or deepening gradually towards the at least one window.

Preferably, the at least one window has an inclination or ramp at a sidewall adjacent to a/the side where the exposure of the at least one window starts upon movement of the second disc from the fully closed rotational position in a/the direction towards the fully open rotational position such that the free opening width of the at least one window in the thickness direction of the first disc becomes gradually narrower with distance from the plane of the first sealing contact surface.

Preferably, the valve assembly is dimensioned so as to provide, within the rotational angular range of the relative movement between the fully closed rotational position and the fully open rotational position, a flowrate through the at least one window from dropwise, preferably 20 ml·min⁻¹, up to at most 5 l·min⁻¹, more preferably at most 4 l·min⁻¹, even more preferably at most 3 l·min⁻¹, and most preferably at most 2 l·min⁻¹.

Preferably, the rotational angular range between the fully closed rotational position and the fully open rotational position is 500-70°, preferably 550-65°, and most preferably about 60°.

Preferably, the first disc is provided with positioning notches for preventing a rotation and defining a mounting position in a receptacle of a liquid dispenser, the positioning notches being formed and/or arranged unsymmetrical about a circumference of the first disc.

Preferably, the second disc is provided with one or more driver recess/recesses and/or protrusion/protrusions on a side opposite to the second sealing contact surface, for engagement with a rotary actuator of a liquid dispenser.

Preferably, the first disc has a circular outer periphery, and the second disc has a non-circular outer periphery with the opening portion arranged to at least partially expose the at least one window of the first disc radially recessed from the outer periphery.

Preferably, the first disc and/or the second disc are made of a ceramic material, preferably aluminum oxide ceramic.

Preferably, the first disc of the valve assembly is rotationally fixed in position within the receptacle such that the at least one window communicates with the outlet, and the second disc is mounted in the receptacle so as to freely float in contact with the first disc and such that the first and second sealing contact surfaces are pressed against each other by the water pressure from the supply piping acting on the second disc.

Preferably, the second disc of the valve assembly is engaged with (or “mechanically connected to”) a manually operable rotary actuator (for example, a handwheel) for rotatingly driving the second disc relative to the first disc between the fully closed rotational position and the fully open rotational position.

The manually operable rotary actuator may be directly or indirectly mechanically connected to the second (“upper”) disc of the present valve assembly. In case of a direct connection, said rotary actuator comprising an optional short axle integrally formed with the rotary actuator rotatingly drives the second disc relative to the first disc between the fully closed rotational position and the fully open rotational position. In case of an indirect connection, said rotary actuator is mechanically connected to the second (“upper”) disc via an axle (or “shaft”), wherein the rotary actuator and the axle are separate pieces. Preferably, the axle may be comprised of two different separate pieces, an axle and a driver, wherein the rotary actuator is mechanically connected to the axle, which in turn is mechanically connected to the driver, which again in turn is mechanically connected to the second (“upper”) disk.

Thus, a preferred dispenser comprises a manually operable rotary actuator (e.g. a handwheel), a valve assembly comprising two ceramic discs, and an axle connecting said rotary actuator to one of said ceramic discs (preferably the second (“upper”) disc), thereby allowing the opening and closing of the valve by turning the rotary actuator.

It is to be understood that the manually operable rotary actuator and the second (“upper”) disk and—if present—the axle and/or the driver, are mechanically connected to each other in such a way as to allow smooth and precise rotational movement, as will be explained in more detail in the following.

The preferred valve assembly as described herein is a mechanical valve assembly including a single pair of discs, preferably made from ceramic material, that can be integrated in the dispenser of water purification systems to replace both, the motorized valve and the solenoid valve. This single pair of discs can be used to control both, the opening and closing of the flow through the valve assembly, as well as the dispensing flowrate from dropwise dispensing to high flowrates, i.e. from 20 ml·min⁻¹ to at most 5 l·min⁻¹, more preferably to at most 4 l·min⁻¹, even more preferably to at most 3 l·min⁻¹, and most preferably to at most 2 l·min⁻¹.

This preferred mechanical valve assembly as described herein, in consequence of its reduced size and complexity, provides one or more of the following advantages over existing products:
(i) The ability to have several dispensers and/or dispensing devices for dispensing at different flowrates at the same time in a single water purification system;
(ii) the size of the dispenser and/or dispensing device can be reduced by removing the solenoid valve (and the motorized valve if provided) and the PCB from the dispenser and/or dispensing device—this provides an improved ergonomic handling of the dispenser and/or dispensing device;
(iii) the number of components and the complexity of the dispenser and/or dispensing device and/or the distribution system can be reduced—in particular, avoiding the electronics means because no power or control circuits must be provided from the main system comprising the water purification unit to the distribution system and/or the dispenser and/or dispensing device, and a connection between the main system to the distribution system and/or dispenser and/or dispensing device may be reduced to a dual or single tubing instead of two separate tubings and electronic cables, which all may have to be integrated in an outer sleeve or bound together by suitable means as, for example, cable ties;
(iv) the simplification of the structure and lack of electronics is also beneficial from an environmental perspective, reducing the carbon footprint of the distribution system and/or the dispensing device and/or the dispenser as well as of the entire water purification system and improving its recyclability;
(v) the possibility to omit electronic parts from the dispensing unit and/or distribution unit further simplifies maintenance and repair of the unit in case of need as no electronic connections need to be made;
(vi) from a manufacturing perspective, the valve assembly together with the liquid dispensing device and/or dispenser provided with it provide for a simplified and more robust, i.e. error free assembly; and
(vii) finally, the valve assembly and the liquid dispensing device and/or dispenser provided with it enhance the freedom of design: having electronic parts close to hydraulic components in a small and closed space poses a risk and puts severe constraints on the design of the purified water distribution system(s) and/or the dispensing device(s) and/or the dispenser(s), forcing a flow entry from the lower part of a dispenser in most existing products. The lack of electronics made possible by the use of the present mechanical valve assembly simplifies the constraints on the design of the distribution system and/or dispensing device and/or dispenser as well as of the overall water purification system, and consequently lowers the risks from that perspective.

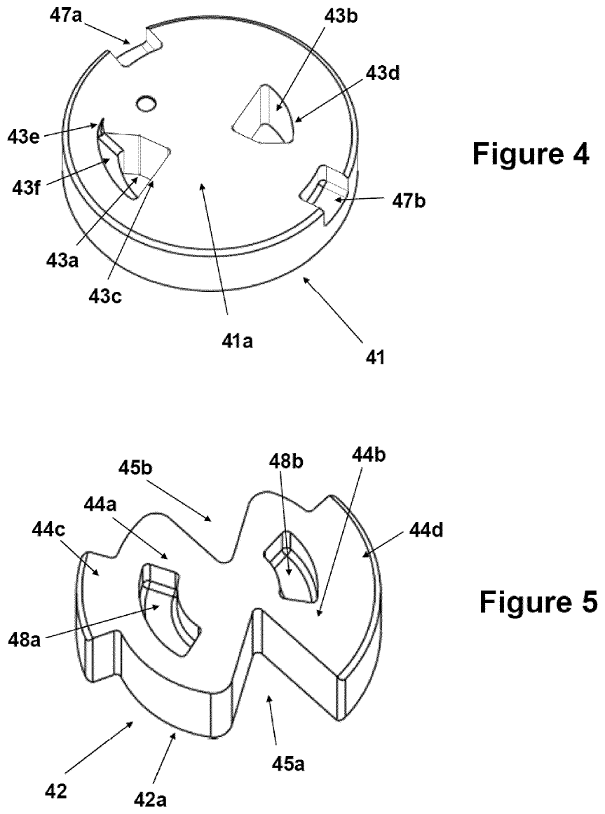

The invention is now described in detail on the basis of preferred exemplary embodiments by reference to the attached exemplary schematic drawings FIGS. 4 through 8a and 8b.

The preferred valve assembly for a liquid dispenser and the liquid dispensing device unit as defined herein, particularly for a water purification system, are now described in connection with an exemplary preferred embodiment.

The valve assembly (40) for a liquid dispenser (31) comprises a pair of first (41) and second discs (42) (see FIG. 3 and FIG. 4, respectively) to be rotated relative to each other with mutually facing first (41a) and second sealing contact surfaces (42a) arranged to at least partly slide in contact with each other.

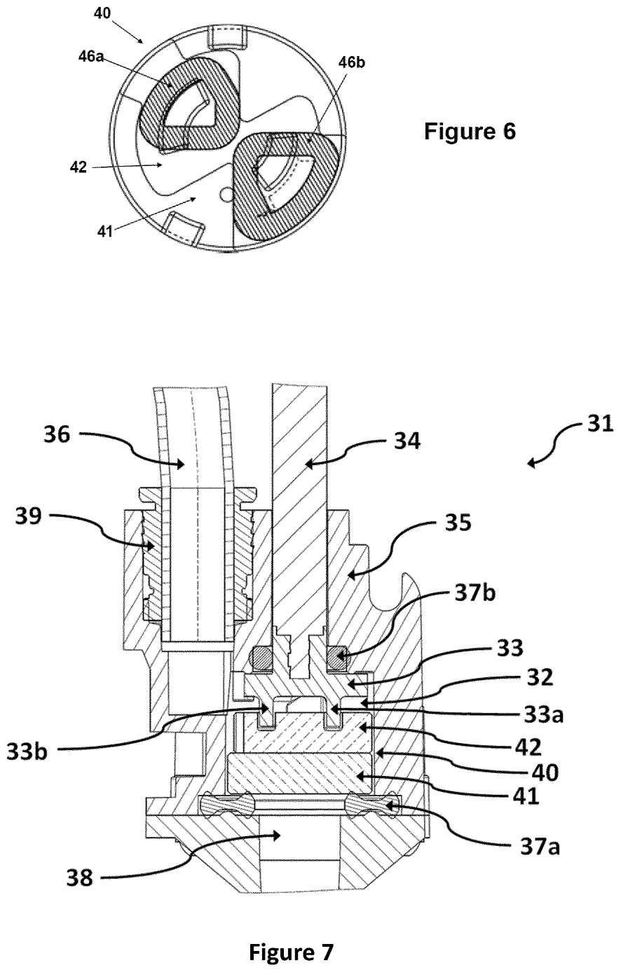

The first disc (41) has at least one window (43a, 43b) (two in the embodiment at positions opposite to each other through the center of the disc). The second disc (42) has a solid portion (44a, 44b) arranged to completely cover and thus to close in an axial direction the at least one window (43a, 43b) of the first disc (41) in a fully closed rotational position (shown in FIG. 6), and an opening portion (45a, 45b) arranged to at least partially expose the at least one window (43a, 43b) of the first disc (41) upon relative rotation in a progressing manner until it is positioned in a fully open rotational position. Here, too, two solid portions (44a, 44b) and two opening portions (45a, 45b) are provided in the embodiment complementary to the two windows (43a, 43b) of the first disc (41).

While two of the windows and corresponding opening portions and solid portions are provided in a rotationally symmetrical manner, the number can be one each or more than two distributed about a circumference.

The windows (43a, 43b) extend through the thickness of the first disc (41) in the axial direction and serve as flow paths for the fluid through the valve assembly (40) in the axial direction as described later.

The solid portion(s) (44a, 44b) of the second disc (42) that is/are arranged to completely cover and thus to close the window(s) (43a, 43b) of the first disc (41) in the fully closed rotational position is/are formed so as to include a portion of the second sealing contact surface (42a) that overlaps the first sealing contact surface (41a) of the first disc (41) within a closed sealing zone (46a, 46b), respectively surrounding an edge (43c, 43d) of the window(s) (43a, 43b). The sealing zone (46a, 46b) has a width of at least 1.5 mm, preferably at least 2.0 mm, measured perpendicularly to the edge or more precisely perpendicularly to a tangent to the edge within the planes of the first and second sealing contact surfaces (41a, 42a) to guarantee sealing in the fully closed position (see FIG. 6). Sealing with the receptacle of a housing of a dispenser (31) in which the valve assembly (41) is integrated is achieved on the surface opposite to the first sealing contact surface (41a) of the first disc (41) (which may be the lower surface of the first disc if arranged as the lower disc in the example of FIG. 7) and therefore requires a certain circular area on the outside of the surface with no openings. These two requirements combined with the need to maximize the opening area of the windows (43a, 43b) to set a desired maximum dispensing rate as defined above determine the sizes and shapes and features of the two discs (41, 42).

The first disc (41) and/or the second disc (42) are preferably made of a ceramic material. As the valve assembly (40) is particularly intended to be integrated in a dispensing device and dispenser (31) for ultrapure water, the type of ceramic material used is to be selected to avoid any contamination to the ultrapure water. Aluminum oxide ceramic is a suitable and preferred material. However, depending on the circumstances and if the required sealing properties of the sealing contact surfaces (41a, 42a) of the discs can be realized, another material including metal or alloys or a different base material with a suitable coating including a ceramic coating are possible.

The first disc (41) in the embodiment has a circular outer periphery and the second disc (42) has a non-circular outer periphery with the opening portion (45a, 45b) arranged to at least partially expose the at least one window (43a, 43b) of the first disc (41) radially recessed from the outer periphery (see FIG. 5). The discs (41, 42) may, however, have a peripheral shape other than circular. If the peripheral shape is “not round”, it may facilitate holding at least one disc (i.e. the stationary disc) in a receptacle of a dispenser (31) to prevent rotation by engagement with a suitable corresponding shape of a recess or a protrusion.

The first disc (41) is provided with positioning notches (47a, 47b) at an outer periphery for preventing—in a mounted state in a receptacle (32) of the dispenser (31) as shown in FIG. 7—a rotation and for defining a unique mounting position in the receptacle (32). The positioning notches (47a, 47b) are formed and/or arranged asymmetrically about a circumference of the first disc (41) in order to define the unique mounting position.

The second disc (42) is provided with one or more driver recess/recesses (48a, 48b) and/or protrusion/protrusions (not shown) on a side opposite to the second sealing contact surface (42a) in the axial direction, for engagement with a rotary actuator (33) of the liquid dispenser (31). In the embodiment the recesses (48a, 48b) are shallow pockets or grooves with a closed bottom that do not extend through the thickness of the second disc (42) in the axial direction. The rotary actuator (33) is provided with matching protrusions (33a, 33b) (see FIG. 7) for engaging with the recesses (48a, 48b). The shape or contour of the recesses (48a, 48b) and matching protrusions (33a, 33b) is unsymmetrical in order to define a unique mounting orientation or more precisely a defined rotation position of the actuator (33) where the engagement is possible.

The sealing properties of the discs (41, 42) depend mainly on the percentage of the sealing contact surfaces (41a, 42a) of the discs that are effectively in contact at the microscopic level. The disc sealing contact surfaces (41a, 42a) are therefore processed to reach a pre-set percentage of the surfaces in contact between the two discs (41, 42). A percentage that is too low would compromise sealing, and a percentage too high would cause excessive efforts of operation. As there are no external forces applied on the discs (41, 42) in the integration in the dispenser (31) as described below, this percentage of the disc surfaces (41a, 42a) in contact, together with the water pressure and the friction forces of the seal on the driving actuator (33), are the only parameters that influence the operation efforts.

The first and second sealing contact surfaces (41a, 42a) of the pair of first and second discs (41, 42) that are arranged to at least partly slide in contact with each other have a surface quality or surface roughness Ra of at most 0.60 μm, more preferably of at most 0.50 μm, most preferably of at most 0.40 μm, and/or a flatness of at most 0.80 μm, preferably of at most 0.70 μm, most preferably of at most 0.60 μm, to create the fluid-tight sealing upon contact. Preferably the first and second sealing contact surfaces (41a, 42a) of the pair of first and second discs (41, 42) are polished or ground.

The mutually facing first and second sealing contact surfaces (41a, 42a) of the pair of first and second discs (41, 42) are arranged such that a percentage of 50-80%, preferably 55-75%, and most preferably 60-70% of the first and second sealing contact surfaces (41a, 42a) are sliding in contact with each other between the fully closed rotational position and the fully open rotational position.

The forces required to operate the valve assembly (40) are directly proportional to the axial forces applied to the discs (41, 42):

$$Friction forces = normal forces * friction coefficient$$

Since the valve assembly is to be integrated in a water dispenser (31), for example in the form of an ergonomic, easy to use dispenser that the user will hold with just one hand and operate with his thumb within a relatively small angular moving range, low operation forces are critical. This differs from similar fluid valves that are driven by a motor or ones where a full hand is used to operate the valve, on a large angular range.

It is therefore critical to reduce as much as possible the force required to open and close the valve assembly (40), for ergonomic operation. To that effect, the axial forces that apply to the discs (41, 42) are to be minimized in order to limit the friction forces between the discs (41, 42) to a minimum. Extensive tests showed that water pressure generally is sufficient to press the discs (41, 42) together and achieve sealing, with no additional forces required.

In the integration of the valve assembly (40) in a dispenser (31) as exemplified in FIG. 7, the second disc (42) is arranged as an upper disc and is preferably mounted freely floating in contact with the first disc (41) in order to minimize forces of operation of the water dispenser (31). There is an axial stop in an upper manifold to determine and fix the altitude of the first or lower disc (41) and sealing is achieved between the first disc (41) and the housing with a custom seal (37a), shown in FIG. 7. There is then a functional gap between the driving actuator (33), i.e. of the protrusions (33a, 33b) in the recesses (48a, 48b) of the second disc (42), to guarantee that no axial forces—other than those resulting from the pressure of the fluid acting on the second disc (42) and pressing it against the first disc (41)—are applied between the discs (41, 42).

Reduced forces and improved ergonomics of operation can also be achieved not only by the optimization of the disc properties and the integration with the freely floating second or upper disc (42), but also by an optimization of the rotating seal on the driving actuator (33).

In certain applications it might be beneficial, to enhance the sealing effect, to slightly bias the second disc (42) towards the first disc (41), by a biasing member (not shown), for example an elastic member like an elastic seal (for example an O-ring) or spring arranged between the driving actuator (33) and the upper surface of the second disc (42). Such biasing member could, for example, be arranged in the space between the protrusions (33a, 33b) and the upper surface of the second disc (42) (not shown in the drawing).

For the intended use in a liquid dispenser (31) for ultrapure water the disc design and the disc properties are optimized to enable a wide range of flowrates: good sealing must be achieved in the fully closed position and flowrates from stable and easy to reach dropwise dispensing up to the maximum dispensing rate as defined herein when the valve assembly (40) is fully open, with limited pressure drops are provided on a limited ergonomic angular range that allows operation when the liquid dispenser (31) is to be used with just one hand and operated with the thumb, while the rest of the hand holds the device.

The discs (41, 42) of the valve assembly (40), in particular the dimensions and arrangement of the window(s) (43a, 43b), of the solid portions (44a, 44b) and of the opening portions (45a, 45b) are thus configured to provide a rotational angular range between the fully closed rotational position and the fully open rotational position to be between 50°-70°, preferably 550-65°, and most preferably about 60°.

The valve assembly (40) is dimensioned so as to provide, within the rotational angular range of the relative movement between the fully closed rotational position and the fully open rotational position, a flowrate through the at least one window (43a, 43b) from dropwise, preferably 20 mL/min, up to the maximum defined dispensing rate as defined herein.

To in particular provide the stable and easy to reach dropwise dispensing from the fully closed position at the beginning of the operating range (or, though in the following not directly described, correspondingly from the fully open position towards the end of the operating range) the at least one window (43a, 43b) of the first disc (41) has a notch/dent (43e) recessed into the material of the first disc (41) from the plane defined by the first sealing contact surface (41a) of the first disc (41) at an/the edge (43c, 43d) of the at least one window (43a, 43b) that is located at a side where the exposure of the at least one window (43a, 43b) starts upon movement of the second disc (42) from the fully closed rotational position in the direction towards the fully open rotational position (see FIGS. 4, 6, and 8b).

The notch/dent (43e) has a pointed sharp tip that gradually and continuously widens in a horizontal direction defined by the extension of the plane of the first sealing contact surface (41a) and/or deepens gradually towards the at least one window (43a, 43b) in the direction perpendicular to that plane. In other words, the surface of the cross section of the notch/dent (43e) increases towards the at least one window (43a, 43b) in the circumferential direction of the first disc (41).

Further, to smoothen the flow of the liquid upon further rotation of the second disc (42) beyond the range of the notch/dent (43e), the at least one window (43a, 43b) has an inclination or ramp (43f) at a sidewall adjacent to the side where the exposure of the at least one window (43a, 43b) starts upon movement of the second disc (42) from the fully closed rotational position in the direction towards the fully open rotational position such that the free opening width or surface of the cross section of the at least one window (43a, 43b) in the thickness or axial direction of the first disc (41) becomes gradually narrower over at least a certain range with distance from the plane of the first sealing contact surface (41a).

As mentioned before the valve assembly (40) of the invention is in particular designed and advantageous for use in a liquid dispenser (31) for a water purification system. The integration of the valve assembly (40) in a preferred embodiment of a liquid dispenser (31) is at least partially shown in the cross-sectional view of FIG. 7. The liquid dispenser (31) that is in the form of an ergonomic, easy to use dispenser to be held by a single hand of a user while the valve assembly (40) is operated by the thumb comprises a housing (35), a supply piping (36) for purified water connected to a port (39) of the housing (35) directed towards the upper side, and an outlet (38) for purified water directed towards the lower side in a typical upright held orientation.

The valve assembly (40) according to the invention is arranged in a receptacle (32) of a housing (35) such that the valve assembly (40) can control the volume or rate of the flow of purified water from the supply piping (36), i.e. an integral multi-lumen tubing as defined herein, to the outlet (38). The receptacle (32) is in communication with the port (39) of the housing (35) and the outlet (38).

The first disc (41) of the valve assembly (40) is rotationally fixed in position within the receptacle (32), for example by protrusions engaging with the positioning notches (47a, 47b) at the outer periphery of the first disc (41) (see FIG. 4) or by the mating shape of the receptacle such that the at least one window (43a, 43b) communicates with the outlet (38). The outer periphery of the surface of the first disc (41) surrounding the lower opening of the window(s) (43a, 43b) is sealed against the housing (35) by means of an annular seal (37a) such that all liquid entering the outlet (38) from the receptacle (32) must pass through the window(s) (43a, 43b) of the first disc (41).

The second disc (42) is shown to be mounted in the receptacle (32) so as to freely float in contact with the first disc (41) and such that the first and second sealing contact surfaces (41a, 42a) are pressed against each other by only the water pressure from the supply piping (36) acting on the second disc (42) as described above.

The second disc (42) of the valve assembly (40) is engaged with a manually operable rotary actuator (33, 34) for rotatingly driving the second disc (42) relative to the first disc (41) between the fully closed rotational position and the fully open rotational position within the above described rotational range. The rotary actuator comprises an axle (34) and a driver (33) connected with a lower end of the axle (34).

Though driver (33) and axle (34) may be made (i.e. essentially consists) of the same material, it is preferred that driver (33) and axle (34) are made of different materials. Preferably, driver (33) is made of (i.e. essentially consists) of a material that has a low content of leachables, i.e. has a low tendency to release contaminants. Non-limiting examples of materials suitable for driver (33) may be selected from the group consisting of polyacetal, and polypropylene. A preferred example of a material suitable for driver (33) is polyoxymethylene (POM). Preferably, axle (34) is made of a material having good mechanical strength, especially on torsion resistance, so as to allow for accurate and precise operation of the ceramic discs, which is particularly necessary to find the dropwise dispensing position. Non-limiting examples of such materials suitable for axle (34) may be selected from the group consisting of polyamides (PA), reinforced (e.g. with fiber reinforcement or talc) polyamides, and reinforced (e.g. with talc) polypropylene. A preferred example of a material suitable for axle (34) is polyphthalamide (PPA).

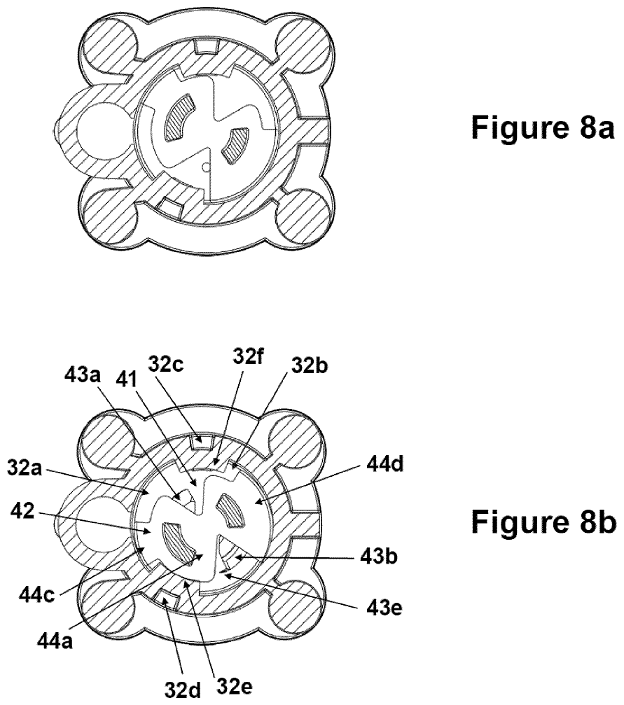

A part of the actuator, not shown in the drawing, extends to the outside of the housing (35) and is accessible for the thumb of the hand to be operated to rotationally drive the second disc (42) and can be shaped according to the desired ergonomics. The rotary actuator is sealed against the housing (35) by an O-ring or gasket (37b) to prevent liquid from escaping the receptacle (32) other than through the outlet (38). The specific design of the actuator is not critical provided the floating positioning and contact of the second disc against the first disc is achieved without introducing additional axial forces in connection with the operation for rotation of the second disc from the fully closed to the fully open rotational position (see also FIGS. 8a and 8b).

In the embodiment the second disc (42) is provided with additional protrusions (44c, 44d) on an outer periphery that are inserted into corresponding peripheral grooves (32a, 32b) of the receptacle (32) so as to guide and limit the rotation range of the rotation of the second disc (42).

In addition to the considerations regarding hydraulic performance and usability, the shapes and features of the two discs (41, 42) are also optimized for a simple and robust assembly process, with very limited possibilities to misassemble (i.e. wrongly assemble) the parts in the housings (35) of the liquid dispenser (31) dispenser. In particular, the positioning notches (47a, 47b) on the first disc (41) used to maintain the first disc (41) in place are not symmetrical, so as to only fit in one position into the receptacle (32) in which it is integrated. The asymmetrical ribs (32c, 32d) in the receptacle (32) that are used to maintain the first or lower disc (41) in a fixed position also prevent the upper disc (42) to be mounted in the wrong angular position (see FIGS. 8a and 8b).

The two protrusions (33a, 33b) (see FIG. 7) for engaging with the recesses (48a, 48b) in the second or mobile disc (42) used to drive valve operation with the rotating actuator (33, 34) are also different from each other, to allow only one angular position relative to an axis of the actuator (33). This is important as the stops on the valve (fully open and fully closed) are defined between the axle and the housing (35).

Ribs (32e, 32f) between the peripheral grooves (32a, 32b) of the receptacle (32) are used for defining these stops and thus also influence the outer shape of the second or mobile disc (42) that should be free to rotate on its operating range despite these ribs (32e, 32f).

The present application further relates to a method for dispensing purified water using the present dispensing device.

Thus, the present method of dispensing purified water comprises the steps of
(A) providing a dispensing device comprising a dispenser and a feeding line as defined herein;
(B) providing purified water through the feeding line to the dispenser; and
(C) dispensing purified water through the dispenser.

Preferably, the present method of dispensing purified water comprises the steps of providing a dispending device as defined herein in detail comprising a feeding line and a dispenser, and providing the dispenser with purified water through the feeding line, opening a valve assembly comprised in the dispenser, dispensing the desired volume of purified water from the dispenser, and closing said valve assembly.

Preferably, step (C) comprises the following steps
(C1) opening a valve assembly comprising two ceramic discs by manually operating a rotary actuator (thereby allowing purified water to flow through the dispenser and through an outlet);
(C2) dispensing the desired volume; and
(C3) closing the valve assembly.

1. A dispensing device for dispensing purified water, the dispensing device comprising:
(a) a dispenser comprising a valve assembly and a water outlet; and
(b) a feeding line providing purified water to the dispenser and removing water from the dispenser,
wherein the feeding line comprises an integral multi-lumen tubing, the integral multi-lumen tubing comprising at least two separate lumens serving as flow paths for feeding water to and from the dispenser, respectively.

2. The dispensing device according to claim 1, wherein the integral multi-lumen tubing comprises a low leachable material.

3. The dispensing device according to claim 1, wherein the feeding line is flexible.

4. The dispensing device according to claim 1, wherein the feeding line comprises a protective sheath surrounding the integral multi-lumen tubing.

5. The dispensing device according to claim 1, wherein the integral multi-lumen tubing comprises at least one central lumen and at least one outer lumen separated/isolated from the central lumen.

6. The dispensing device according to claim 5, wherein the integral multi-lumen tubing comprises at least two outer lumens distributed symmetrically about the at least one central lumen.

7. The dispensing device according to claim 5, wherein the feeding line is connected or connectable to a water purification unit such that the flow of purified water towards the dispenser is directed through at least one of the at least one central lumen and any flow of purified water back to the purification unit and/or another dispenser is directed through one or more of the at least one outer lumen.

8. The dispensing device according to claim 1, wherein the valve assembly of the dispenser comprises two ceramic discs.

9. The dispensing device according to claim 1, wherein the dispenser comprises a manually operable rotary actuator, and the valve assembly comprises two ceramic discs, wherein the rotary actuator is mechanically connected to one of said ceramic discs.

10. The dispensing device according to claim 1, wherein the dispensing device and/or the dispenser do not require electricity.

11. A water purification system comprising the dispensing device of claim 1.

12. Method of dispensing purified water, the method comprising the steps of
(A) providing a dispensing device of claim 1;
(B) providing purified water through a feeding line to the dispenser; and
(C) dispensing purified water through the dispenser.

13. Method according to claim 12, further comprising removing purified water from the dispenser, wherein the purified water is provided to and removed from the dispenser through the at least two separate lumens, respectively.

14. The dispensing device according to claim 1, wherein the integral multi-lumen tubing consists of a low leachable material.

15. The dispensing device according to claim 1, wherein the integral multi-lumen tubing comprises a low leachable polymer.

16. The dispensing device according to claim 1, wherein the integral multi-lumen tubing consists of a low leachable polymer.

17. The dispensing device according to claim 16, wherein the low leachable polymer is low-density polyethylene.

18. The dispensing device according to claim 1, wherein the integral multi-lumen tubing comprises at least one central lumen and plural outer lumens separated/isolated from the central lumen.

19. The dispensing device according to claim 5, wherein the integral multi-lumen tubing comprises at least three outer lumens distributed symmetrically about the at least one central lumen.

20. The dispensing device according to claim 5, wherein the integral multi-lumen tubing comprises at least four outer lumens distributed symmetrically about the at least one central lumen.
